(19) United States
(12) Patent Application Publication
(10) Pub. No.: US 2025/0293789 A1
(43) Pub. Date: Sep. 18, 2025

(54) COMMUNICATION METHOD AND DEVICE USING SERIAL PERIPHERAL INTERFACE (SPI)

(71) Applicant: HYUNDAI MOBIS CO., LTD., Seoul (KR)

(72) Inventor: Ye Jin LEE, Anyang-si (KR)

(73) Assignee: HYUNDAI MOBIS CO., LTD., Seoul (KR)

(21) Appl. No.: 18/950,337

(22) Filed: Nov. 18, 2024

(30) Foreign Application Priority Data
Mar. 14, 2024 (KR) 10-2024-0035965

(51) Int. Cl. H04J 3/06

(52) U.S. Cl. CPC H04J 3/0685; H04J 3/0673

(57) ABSTRACT

A communication method, a communication device, and a method for communication using a serial peripheral interface (SPI) are provided. The communication method includes: generating a transmission clock and a reception clock which are synchronized with each other; transmitting the transmission clock to a slave; receiving master in slave out (MISO) data from the slave; determining whether a first bit is included in the MISO data; and counting a second bit in response to the first bit being included in the MISO data.

### CROSS-REFERENCE TO RELATED APPLICATION(S)

This application is based on and claims priority under 35 U.S.C. § 119 to Korean Patent Application No. 10-2024-0035965, filed on Mar. 14, 2024, in the Korean Intellectual Property Office, the entire disclosure of which is hereby incorporated by reference for all purposes.

### BACKGROUND

### 1. Field

The disclosure relates to a communication system and, more specifically, to a method and a device for performing serial communication by using a serial peripheral interface (SPI) protocol.

### 2. Description of the Related Art

A serial peripheral interface (SPI) is a type of communication protocol that performs data transmission and reception between integrated circuits (ICs), so as to transmit specific information to a predetermined IC and allow information of the IC to be known. Particularly, the SPI is widely used for data transmission and reception between a host processor, also referred to as a master, and one or more peripheral devices, also referred to as slaves.

In such SPI communication, a master controls the overall communication, and thus a slave cannot request communication from the master first. In addition, the SPI communication is based on 1:1 communication but, by using a chip select (CS) signal, may perform 1:N communication to control multiple slaves. The master generates a shift clock (SCLK) which is a clock for SPI communication, selects a slave to perform communication through a CS signal, and transmits data to the slave through master out slave in (MOSI).

In addition, the master receives data through master in slave out (MISO) which is synchronized with the SCLK.

Meanwhile, in such SPI communication, signal delay may occur when the SCLK generated in the master is input to the slave. In addition, the slave may transmit MISO data according to the SCLK in which a signal delay occurs, and a signal delay may also occur in a corresponding signal. Therefore, the master that uses an SCLK having no delay time as a data capture clock may have data loss when receiving MISO data having a delay time.

Therefore, in this technical field, there is a demand for a technology that enables a master to receive MISO data from a slave without data loss.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

The technical task of the disclosure is to provide a method and a device that enable a master to receive MISO data from a slave without data loss.

The technical subjects pursued in the present disclosure may not be limited to the above-mentioned technical subjects, and other technical subjects which are not mentioned may be clearly understood from the following descriptions by those skilled in the art to which the present disclosure pertains.

In a general aspect of the disclosure, a communication method includes: generating a transmission clock and a reception clock which are synchronized with each other; transmitting the transmission clock to a slave; receiving master in slave out (MISO) data from the slave; determining whether a first bit is included in the MISO data; and counting a second bit in response to the first bit being included in the MISO data.

The communication method further includes: generating the MISO data by the slave at a time synchronized with the transmission clock; and receiving the MISO data with a time delay equal to a sum of a first transmission delay occurring while data is transmitted to the slave, wherein a second transmission delay occurs while data is received from the slave.

The MISO data may include a 1-bit “start” field and an n-bit “data word” field, wherein the “start” field may correspond to the first bit, the “data word” field may correspond to the second bit, and the n may be an integer of 1 or more.

The first bit may include a value of “1”.

The determining of whether the first bit is included in the MISO data and the counting of the second bit may be performed at a time synchronized with the reception clock.

The communication method may further include terminating the generation of the reception clock.

In another general aspect of the disclosure, a communication device includes: a transmission clock generator configured to generate a transmission clock to transmit the transmission clock to a slave; a reception clock generator configured to generate a reception clock at a time synchronized with the transmission clock; a master in slave out (MISO) shift register configured to receive MISO data from the slave; and a bit counter configured to: determine whether a first bit is included in the MISO data; and count a second bit in response to the first bit being included in the MISO data.

The MISO data may be generated by the slave at a time synchronized with the transmission clock, wherein the MISO data may be received with a time delay equal to a sum of a first transmission delay occurring while data is transmitted to the slave, and wherein a second transmission delay may occur while data is received from the slave.

The MISO data may include a 1-bit “start” field and an n-bit “data word” field, wherein the “start” field may correspond to the first bit, the “data word” field may correspond to the second bit, and the n may be an integer of 1 or more.

The first bit may include a value of “1”.

The bit counter may be configured to determine whether the first bit is included in the MISO data, and count the second bit at a time synchronized with the reception clock.

In yet another general aspect of the disclosure, a method for communication using a serial peripheral interface (SPI), includes: generating, by a host processor, a transmission clock and a reception clock which are synchronized with each other; transmitting, by the host processor via a Master In Slave Out (MISO) data line in the SPI, the transmission clock to a slave comprising a peripheral device; receiving, by the host processor via the MISO data line, MISO data from the slave; determining, by the host processor, whether a first bit is included in the MISO data; and counting, by the host processor, a second bit in response to the first bit being included in the MISO data.

The method may further include: generating the MISO data by the slave at a time synchronized with the transmission clock; and receiving the MISO data by the host processor with a time delay equal to a sum of a first transmission delay occurring while data is transmitted to the slave, wherein a second transmission delay occurs while data is received from the slave.

The MISO data may include a 1-bit “start” field and an n-bit “data word” field, wherein the “start” field may correspond to the first bit, the “data word” field may correspond to the second bit, and the n may be an integer of 1 or more.

The first bit may include a value of “1”.

The determining of whether the first bit is included in the MISO data and the counting of the second bit may be performed at a time synchronized with the reception clock.

The method may further include terminating the generation of the reception clock.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a block diagram schematically showing a structure of a general SPI communication system including a master and a slave;

FIG. 2 is a graph illustratively showing that data loss may occur due to a delay time occurring in MISO in the SPI communication system of FIG. 1;

FIG. 3 is a block diagram schematically showing a structure of an SPI communication system according to an embodiment of the disclosure;

FIG. 4 shows a data structure of an MISO packet according to an embodiment of the disclosure;

FIG. 5 is a graph illustratively showing that a master may receive MISO of a slave without data loss in an SPI communication system according to the embodiment of FIG. 3; and

FIG. 6 is a flowchart showing an SPI communication method according to an embodiment of the disclosure.

### DETAILED DESCRIPTION

Hereinafter, the present disclosure will be described in detail with reference to the accompanying drawings. Herein, a detailed description of known functions or configurations that may make the subject matter of the disclosure unnecessarily unclear will be omitted. Embodiments of the present disclosure are provided to more completely explain the present disclosure to a person having ordinary skill in the art. Therefore, the shapes and sizes of elements in the drawings may be exaggerated for a clearer explanation.

Hereinafter, exemplary embodiments of the present disclosure will be described in detail in conjunction with the accompanying drawings.

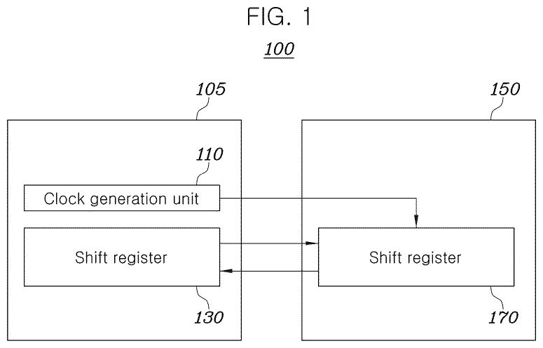

FIG. 1 is a block diagram schematically showing a structure of a general SPI communication system including a master and a slave.

Referring to FIG. 1, an SPI communication system 100 includes a master 105 and a slave 150.

In this case, each of the master 105 and the slave 150 includes four communication ports, and the four communication ports are connected by an SPI clock (SCLK) transmission line for controlling a synchronization signal, a slave selection (CS) line, and a master in slave out (MISO) line and a master out slave in (MOSI) line which are used for data transmission.

The master 105 includes a clock generation unit 110 and a shift register 130.

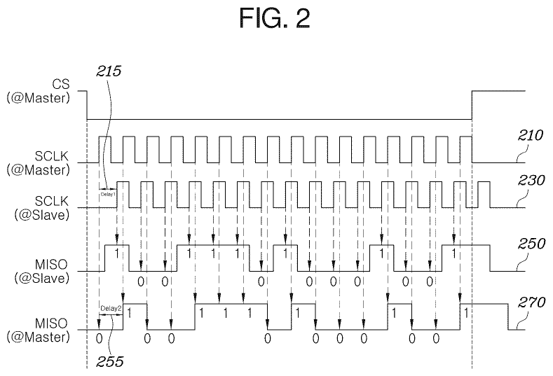

Referring to FIG. 2 together with FIG. 1, the clock generation unit 110 generates a master-side SPI clock 210 to transmit the clock to a shift register 170 of the slave 150.

The shift register 170 of the slave 150 receives a slave-side SPI clock 230 time-delayed by a first transmission delay 215 during a data reception process from the master-side SPI clock 210 of the clock generation unit 110, and generates slave-side MISO 250, based on the received clock, to transmit the MISO to the shift register 130 of the master 105.

For example, the slave-side MISO 250 may indicate data of “1001110100010011”.

In addition, the shift register 130 of the master 105 receives master-side MISO 270 time-delayed by a second transmission delay 255 from the shift register 170 of the slave 150.

When the master-side MISO 270 restores a value indicated based on the initial master-side SPI clock 210, the restored value is “0100111010001001”, data loss occurs due to a time delay caused by a signal delayed by one clock cycle for the slave-side MISO 250.

Hereinafter, an SPI communication system according to an embodiment of the disclosure that solves this problem will be described.

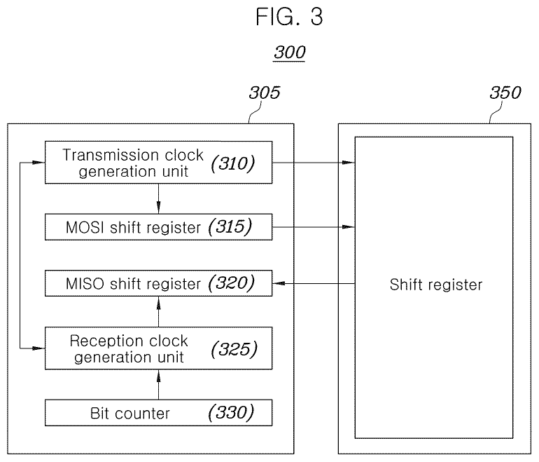

FIG. 3 is a block diagram schematically showing a structure of an SPI communication system according to an embodiment of the disclosure.

Referring to FIG. 3, an SPI communication system 300 includes a master 305 and a slave 350.

The master 305 includes a transmission clock generation unit 310, an MOSI shift register 315, an MISO shift register 320, a reception clock generation unit 325, and a bit counter 330.

Referring to FIG. 3 together with FIG. 5, the transmission clock generation unit 310 generates a transmission SCLK 510 to transmit the transmission SCLK to the slave 350, and the reception clock generation unit 325 generates a reception SCLK 520.

In this case, the transmission SCLK 510 is a synchronization clock for synchronizing data to be transmitted to the slave 350, and the reception SCLK 520 is a synchronization clock for synchronizing data received from the slave 350.

The MOSI shift register 315 generates MOSI data for transmission to the slave 350.

The MISO shift register 320 receives MISO data from the slave 350.

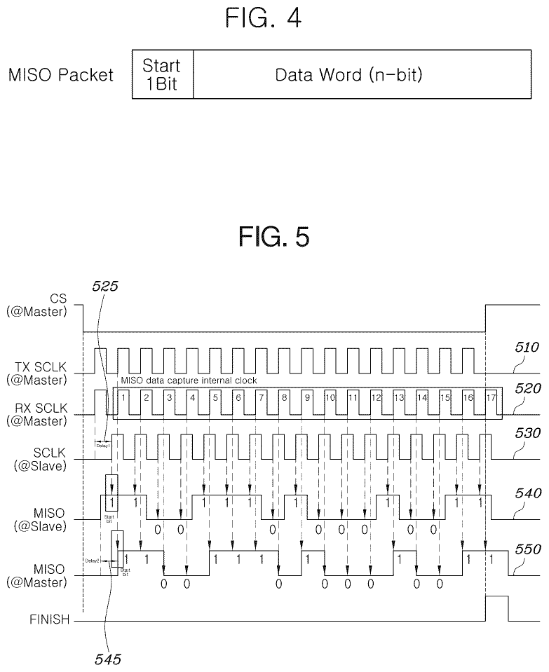

In this case, the MISO data received from the slave 350 may consist of a packet as shown in FIG. 4.

Referring to FIG. 4, the MISO data includes a 1-bit “start” field and an n-bit “data word” field.

In this case, the “start” field may have a value of “1”.

The bit counter 330 monitors the MISO shift register 320, and thus, when a start bit having a value of “1” is received, starts counting a data bit and transmits a clock generation termination signal to the reception clock generation unit 325.

In this case, the start bit may be defined as a first bit, and the data bit may be defined as a second bit.

Referring again to FIG. 5 together with FIG. 3, the transmission clock generation unit 310 generates a transmission (Tx) SCLK 510 to transmit the transmission SCLK to a shift register 370 of the slave 350, and the reception clock generation unit 325 generates a reception (Rx) SCLK 520.

The shift register 370 of the slave 350 receives a slave-side SCLK 530 time-delayed by a first transmission delay 525 from the transmission clock generation unit 310, and generates slave-side MISO 540, based on the received SCLK, to transmit the MISO to the MISO shift register 320 of the master 305.

For example, the slave-side MISO 540 may include a “start” field having a value of “1” and a “data word” field having a value of “1001110100010011”.

In addition, the MISO shift register 320 of the master 305 receives master-side MISO 550 time-delayed by a second transmission delay 545 from the MISO shift register 370 of the slave 350.

In this case, the bit counter 330 detects a “start” field having a value of “1” from the master-side MISO 550 received at a time synchronized with the reception SCLK 520, and receives data in a “data word” field, based on the detected “start” field.

In this case, the bit counter 330 captures MISO data at a time synchronized with the reception clock from a time when the “start” field is detected, and can thus prevent data loss due to a delay time.

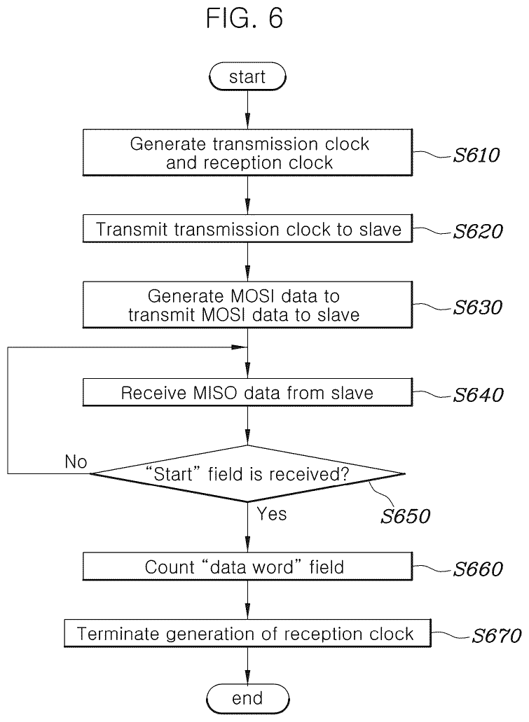

FIG. 6 is a flowchart showing an SPI communication method according to an embodiment of the disclosure.

An SPI communication method according to this embodiment may be performed by the master 305 of FIG. 3.

Referring to FIG. 6, the master 305 generates a transmission clock and a reception clock (S610).

In this case, the transmission clock may be generated by the transmission clock generation unit 310, and the reception clock may be generated by the reception clock generation unit 325.

In this case, the transmission clock and the reception clock may have the same width and frequency.

In addition, the master 305 transmits the generated transmission clock to the slave 350 (S620).

In addition, the master 305 generates master out slave in (MOSI) data to transmit the MOSI data to the slave 350 (S630).

In this case, the generation of the MOSI data may be performed by the MOSI shift register 315.

In addition, the master 305 receives master in slave out (MISO) data from the slave 350 (S640).

In this case, the MISO data received by the master 305 is generated at a time synchronized with the transmission clock, and may be received with a time delay equal to the sum of a first transmission delay occurring while data is transmitted from the master to the slave, and a second transmission delay occurring while data is transmitted from the slave to the master.

In this case, the MISO data may include a 1-bit “start” field and an n-bit “data word” field, as shown in FIG. 4.

In this case, the “start” field may have a value of “1”.

In this case, the n may be an integer of 1 or more.

In addition, the master 305 monitors the MISO shift register 320, so as to determine whether a “start” field having a value of “1”, that is, a start bit, is received (S650), when the “start” field having a value of “1” is received, starts counting a “data word” field, that is, a data bit (S660), and transmits a clock generation termination signal to the reception clock generation unit 325, so as to terminate the generation of the reception clock (S670).

In this case, the monitoring of the MISO shift register 320 may be performed by the bit counter 330.

In this case, the bit counter 330 may detect the “start” field having a value of “1” from the received MISO data at a timing synchronized with the reception clock, and count data in the “data word” field, based on the detected “start” field.

In this case, the bit counter 330 captures MISO data at a time synchronized with the reception clock from a time when the “start” field is detected, and can thus prevent data loss due to a delay time.

If the start bit is not received as a result of the determination in operation S650, the master continues to receive the MISO data from the slave (S640), and repeatedly performs the operation of determining whether the start bit is received (S650).

According to the disclosure, when the master receives MISO data from the slave, the master can receive the MISO data without data loss.

In addition, a delay time of MISO data can be compensated for without an additional clock and data line.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Therefore, the above detailed description should not be construed in a limitative sense, but should be considered in an illustrative sense in all aspects. The scope of the present disclosure shall be determined by reasonable interpretation of the appended claims, and all changes and modifications within an equivalent range of the present disclosure fall within the scope of the present disclosure.

What is claimed is:

1. A communication method comprising:
generating a transmission clock and a reception clock which are synchronized with each other;
transmitting the transmission clock to a slave;
receiving master in slave out (MISO) data from the slave;
determining whether a first bit is included in the MISO data; and
counting a second bit in response to the first bit being included in the MISO data.

2. The communication method of claim 1, further comprising:
generating the MISO data by the slave at a time synchronized with the transmission clock; and
receiving the MISO data with a time delay equal to a sum of a first transmission delay occurring while data is transmitted to the slave,
wherein a second transmission delay occurs while data is received from the slave.

3. The communication method of claim 1,
wherein the MISO data comprises a 1-bit “start” field and an n-bit “data word” field, and
wherein the “start” field corresponds to the first bit, the “data word” field corresponds to the second bit, and the n is an integer of 1 or more.

4. The communication method of claim 1, wherein the first bit comprises a value of “1”.

5. The communication method of claim 1, wherein the determining of whether the first bit is included in the MISO data and the counting of the second bit are performed at a time synchronized with the reception clock.

6. The communication method of claim 1, further comprising terminating the generation of the reception clock.

7. A communication device comprising:
a transmission clock generator configured to generate a transmission clock to transmit the transmission clock to a slave;
a reception clock generator configured to generate a reception clock at a time synchronized with the transmission clock;
a master in slave out (MISO) shift register configured to receive MISO data from the slave; and
a bit counter configured to:
determine whether a first bit is included in the MISO data; and
count a second bit in response to the first bit being included in the MISO data.

8. The communication device of claim 7,
wherein the MISO data is generated by the slave at a time synchronized with the transmission clock,
wherein the MISO data is received with a time delay equal to a sum of a first transmission delay occurring while data is transmitted to the slave, and
wherein a second transmission delay occurs while data is received from the slave.

9. The communication device of claim 7,
wherein the MISO data comprises a 1-bit “start” field and an n-bit “data word” field, and
wherein the “start” field corresponds to the first bit, the “data word” field corresponds to the second bit, and the n is an integer of 1 or more.

10. The communication device of claim 7, wherein the first bit comprises a value of “1”.

11. The communication device of claim 7, wherein the bit counter is configured to:
determine whether the first bit is included in the MISO data; and
count the second bit at a time synchronized with the reception clock.

12. A method for communication using a serial peripheral interface (SPI), the method comprising:
generating, by a host processor, a transmission clock and a reception clock which are synchronized with each other;
transmitting, by the host processor via a Master In Slave Out (MISO) data line in the SPI, the transmission clock to a slave comprising a peripheral device;
receiving, by the host processor via the MISO data line, MISO data from the slave;
determining, by the host processor, whether a first bit is included in the MISO data; and
counting, by the host processor, a second bit in response to the first bit being included in the MISO data.

13. The method of claim 12, further comprising:
generating the MISO data by the slave at a time synchronized with the transmission clock; and
receiving the MISO data by the host processor with a time delay equal to a sum of a first transmission delay occurring while data is transmitted to the slave,
wherein a second transmission delay occurs while data is received from the slave.

14. The method of claim 12,
wherein the MISO data comprises a 1-bit “start” field and an n-bit “data word” field, and
wherein the “start” field corresponds to the first bit, the “data word” field corresponds to the second bit, and the n is an integer of 1 or more.

15. The method of claim 12, wherein the first bit comprises a value of “1”.

16. The method of claim 12, wherein the determining of whether the first bit is included in the MISO data, and the counting of the second bit are performed at a time synchronized with the reception clock.

17. The method of claim 12, further comprise terminating the generation of the reception clock.
